(19) United States
(12) Patent Application Publication
(10) Pub. No.: US 2008/0197594 A1
(43) Pub. Date: Aug. 21, 2008

(54) PIVOTING HANDLEBAR ASSEMBLY CONNECTOR

(76) Inventor: Ching-Chih LING, Kaohsiung Hsien (TW)

Correspondence Address: Rabin & Berdo, P.C., Suite 500, 1101 14th Street, Washington, DC, 20005, US

(21) Appl. No.: 11/676,602

(22) Filed: Feb. 20, 2007

(51) Int. Cl. B62K 5/08

(52) U.S. Cl. 280/87.041; 280/268

(57) ABSTRACT

A pivoting handlebar assembly connector is mounted on a scooter and has a housing, two stationary frames and a stem. The housing has an outer tube. The outer tube has a pivot slot formed through a sidewall of the housing. The stationary frames are attached to the sidewall of the outer tube and a front axle housing of the scooter. The stem attaches to the housing and has a pivotal bar a bolt and a nut. The pivotal bar securely connects to a bottom end of the stem and attaches to the mounting collar and pivots in the housing. The bolt extends through the pivotal bar. The nut screws onto the bolt to hold the pivotal bar in the mounting collar and to allow the pivotal bar to pivot in the pivot slot.

### BACKGROUND OF THE INVENTION

1. Field of the Invention

The present invention relates to a handlebar assembly connector, especially to a pivoting handlebar assembly connector that can be assembled easily and attached firmly to a scooter.

2. Description of the Prior Art

Scooters comprise a footboard, wheels and a handlebar assembly and are becoming more and more popular because they are recreational and convenient. However, riders who turn scooters more sharply and cause the footboard and the handlebar to tilt, and this often results in the riders falling. To overcome the shortcomings, a conventional pivoting handlebar assembly connector keeps the handlebar horizontal when the footboard tilts.

With reference to FIG. 6, a conventional pivoting handlebar assembly connector for a scooter comprises a stem (60), an axle housing (70) and a pivot bracket (80).

The stem (60) has a bottom end and a pivotal tube (61). The pivotal tube (61) is connected to the bottom end of the stem (60).

The axle housing (70) is tubular.

The pivot bracket (80) is connected securely to the axle housing (70) and pivotally to the stem (60), pivotally holds the pivotal tube (61) and has a lower bracket (82) and an upper bracket (81).

The lower bracket (82) corresponds to and pivotally holds the pivotal tube (61) and has two opposite edges and two flanges (820). The flanges (820) are formed respectively along and protrude radially out from the two edges and have multiple fastening holes (821).

The upper bracket (81) is mounted around the stem (60), pivotally holds the pivotal tube (61) in the lower bracket (82) and has two opposite edges, a pivot slot (812), two flanges (810). The pivot slot (812) is formed transversely through the upper bracket (81) between the edges and is mounted around the stem (60). The two flanges (810) are formed respectively on and protrude radially out from the edges and have multiple fastening holes (811) and multiple bolts (813). The fastening holes (811) correspond to and align respectively with the fastening holes (821) through the flanges (820) of the lower bracket (82). The bolts (813) extended respectively through the aligned fastening holes (811, 821) in the flanges (810, 820) of the upper and lower brackets (81, 82), and each bolt (813) has a nut (814). The nuts (814) screw respectively onto the bolts (813) to securely hold the upper bracket (81) on the lower bracket (82). Thus a handlebar connected the stem (60) will keep horizontal as the footboard of the scooter tilts.

However, the conventional pivoting handlebar assembly connector attaches the stem (60) to the pivot bracket (80) with bolts (813) and nuts (814) connecting the flanges (810, 820) of the upper and lower brackets (81, 82). The stem (60) might not be securely mounted. The upper and lower brackets (81, 82), especially the flanges (810, 820) of the brackets (81,82), might be deformed during assembly, and this may prevent the pivoting handlebar assembly connector from working properly. The pivotal tube (61) might shake in the pivot bracket (80) especially if gaps develop between the pivotal tube (61) and the pivot bracket (80). Moreover, a complex procedure is required to assemble the conventional pivoting handlebar assembly connector. A mistake during the assembly of the pivoting handlebar connector could easily cause the scooter to be dangerous.

To overcome the shortcomings, the present invention provides a pivoting handlebar assembly connector to mitigate or obviate the aforementioned problems.

### SUMMARY OF THE INVENTION

The main objective of the present invention is to provide a pivoting handlebar assembly connector that can be assembled easily and attached firmly to a scooter. The pivoting handlebar assembly connector in accordance with the present invention is mounted on the scooter and has a housing, two stationary frames and a stem. The housing has an outer tube, a mounting collar and two end caps. The outer tube has a pivot slot formed through a sidewall of the housing. The mounting collar has two mounting slots formed through the sidewall and aligned with the pivot slot in the outer tube. Two end caps are mounted in the outer tube. The stationary frames are attached to the sidewall of the outer tube and each stationary frame has a tubular connector that securely connects to a bottom end of the stationary frame and is mounted around a front axle housing. The stem attaches to the housing and has a clamp, a pivotal bar, two washers, a bolt and a nut. The clamp is mounted around the stem to prevent the stem from sliding up and down. The pivotal bar is formed on the bottom end of the stem, attaches to the mounting collar of the housing and pivots in the housing. Two washers are mounted in the mounting collar and abut opposite sides of the pivotal bar. The bolt extends through the washers and the pivotal bar. The nut screws onto the bolt and squeezes the washers tightly against the pivotal bar to hold the pivotal bar in the mounting collar and to allow the pivotal bar to pivot in the pivot slot.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a pivoting handlebar assembly connector in accordance with the present invention;

FIG. 2 is a side view in partial section of the pivoting handlebar assembly connector in FIG. 1;

FIG. 3 is a front view of the pivoting handlebar assembly connector in FIG. 1 with internal elements shown in phantom lines;

FIG. 4 is an operational front view of the pivoting handlebar assembly connector in FIG. 1 with internal elements shown in phantom lines;

FIG. 5 is a perspective view of a scooter with the pivoting handlebar assembly connector in FIG. 1; and

FIG. 6 is an exploded perspective view of a conventional pivoting handlebar assembly connector in accordance with the prior art.

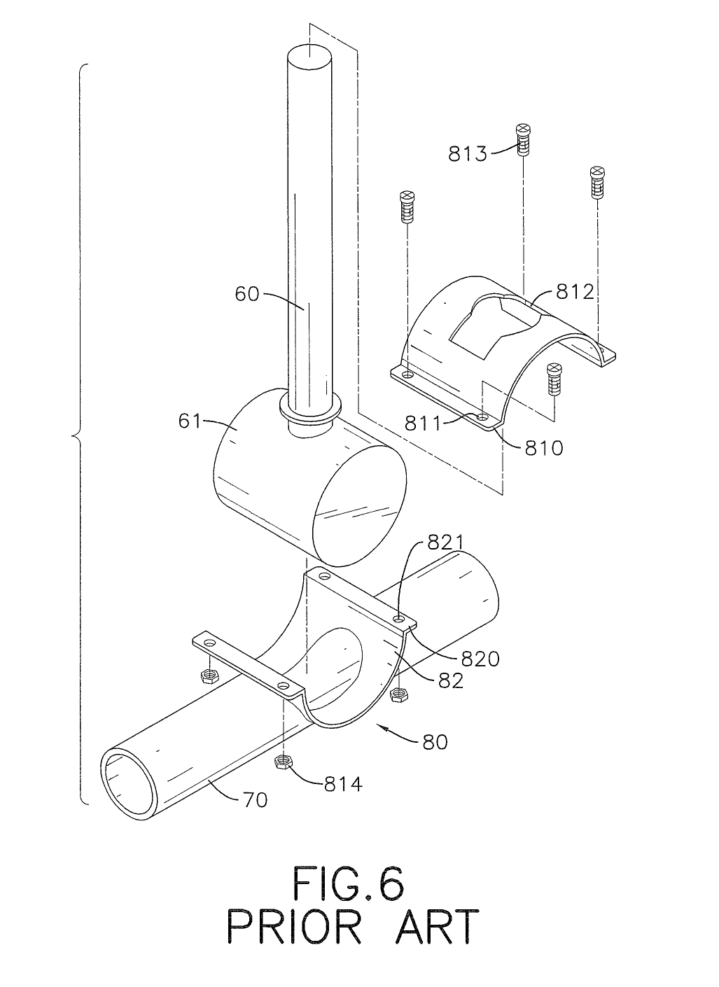

### DETAILED DESCRIPTION OF THE PREFERRED EMBODIMENTS

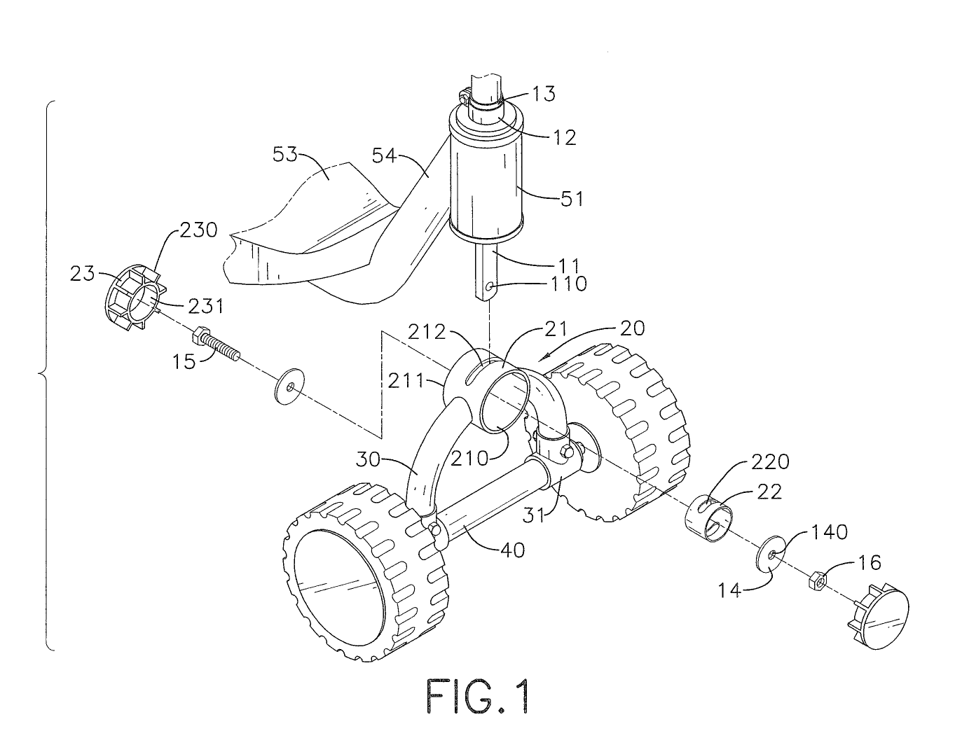

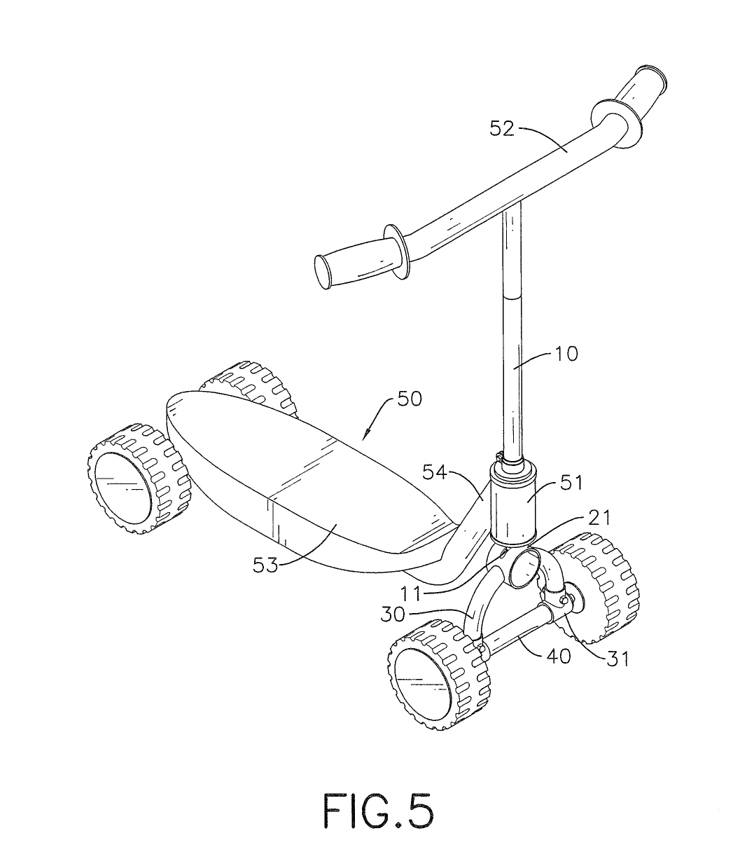

With reference to FIGS. 1 and 5, a pivoting handlebar assembly connector in accordance with present invention is mounted on a scooter (50) and comprises a housing (20), two stationary frames (30) and a stem (10).

The scooter (50) has a head tube (51), a frame (54), a footboard (53), a handlebar (52) and a front axle housing (40). The head tube (51) has a sidewall, a through hole, an upper surface and a bottom surface. The frame (54) is attached to the sidewall of the head tube (51). The footboard (53) is mounted on the frame (54). The front axle housing (40) has two ends. The ends of the front axle housing (40) connect respectively to two wheels.

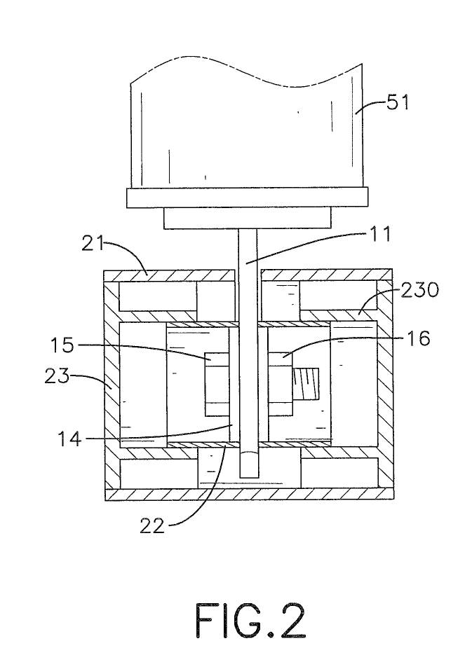

With further reference to FIG. 2, the housing (20) has an outer tube (21), a mounting collar (22) and two end caps (23). The outer tube (21) has a sidewall, a pivot slot (212), a front opening (210) and a rear opening (211). The sidewall has an inner surface. The pivot slot (212) is formed transversely through the sidewall of the outer tube (21). The mounting collar (22) is mounted rotatably in the outer tube (21) and has a sidewall, and two mounting slots (220). The mounting slots (220) are formed transversely through the sidewall of the mounting collar (22) diametrically opposite to each other and align with the pivot slot (212) in the outer tube (21). The two end caps (23) are mounted respectively in the front opening (210) and the rear opening (211) of the outer tube (21), and each end cap (23) has a disk, a tube and multiple optional fins (230). The disks correspond respectively to and close the front opening (210) and the rear opening (211) of the outer tube (21). The tube is formed coaxially on the disk, protrudes into a corresponding opening (210, 211) in the outer tube (21) and has a mounting hole (231). The mounting hole (231) is mounted around and holds the mounting collar (22). The fins (230) are formed on the disk around the tube and abut the inner surface of the sidewall of the outer tube (21).

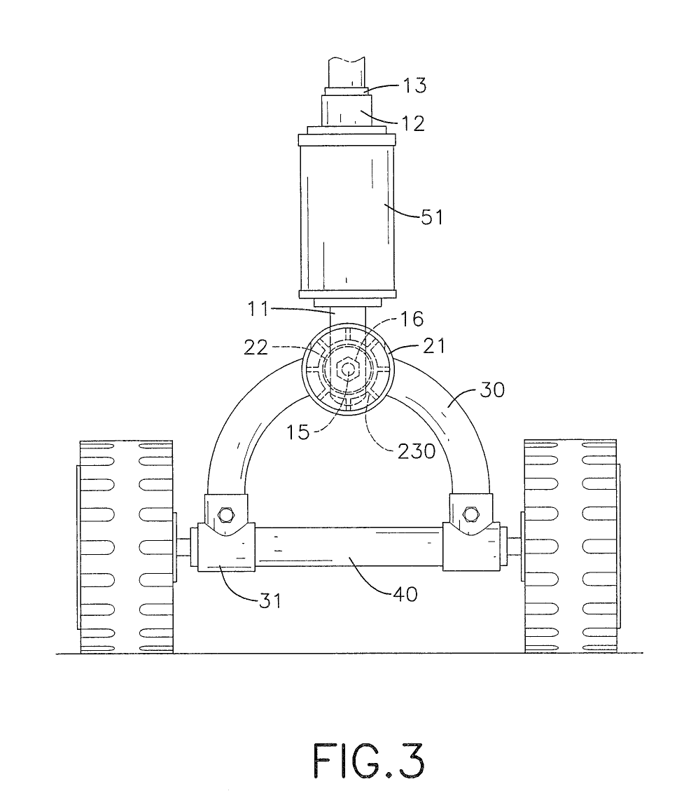

With further reference to FIG. 3, the two stationary frames (30) are curved and are attached to the sidewall of the outer tube (21) near the pivot slot (212) diametrically opposite to each other, and each stationary frame (30) has an upper end, a bottom end and a tubular connector (31). The upper end of the stationary frame (30) is attached to the outer tube (21). The tubular connector (31) securely connects to the bottom end of the stationary frame (30) and is mounted around the front axle housing (40).

The stem (10) is attached to and protrudes down from the handlebar (52), is turned when the handlebar (52) turns, is mounted rotatably through the through hole in the head tube (51), attaches to the housing (20) and has an upper end, a bottom end, a clamp (12), an optional gasket (13), a pivotal bar (11), two washers (14), a bolt (15) and a nut (16). The upper end of the stem (10) is attached to the handlebar (52) of the scooter (50). The clamp (12) is mounted around the stem (10) adjacent to the upper surface of the head tube (51) and prevents the stem (10) from sliding up and down. The gasket (13) is mounted around the stem (10) and abutting with the clamp (12). The pivotal bar (11) is formed coaxially on and protrudes from the bottom end of the stem (10), attaches to the mounting collar (22) to turn the front wheels, pivotally extends into the housing (20) and has two sides and a pivot hole (110). The two washers (14) are mounted rotatably in the mounting collar (22) and respectively abut opposite sides of the pivotal bar (11), and each washer (14) has a through hole (140). The through hole (140) is formed concentrically through the washer (14). The bolt (15) extends through the washers (14) and the pivotal bar (11). The nut (16) screws onto the bolt (15) and squeezes the washers (14) tightly against the pivotal bar (11) to hold the pivotal bar (11) in the mounting collar (22) and allow the pivotal bar (11) to pivot in the pivot slot (212).

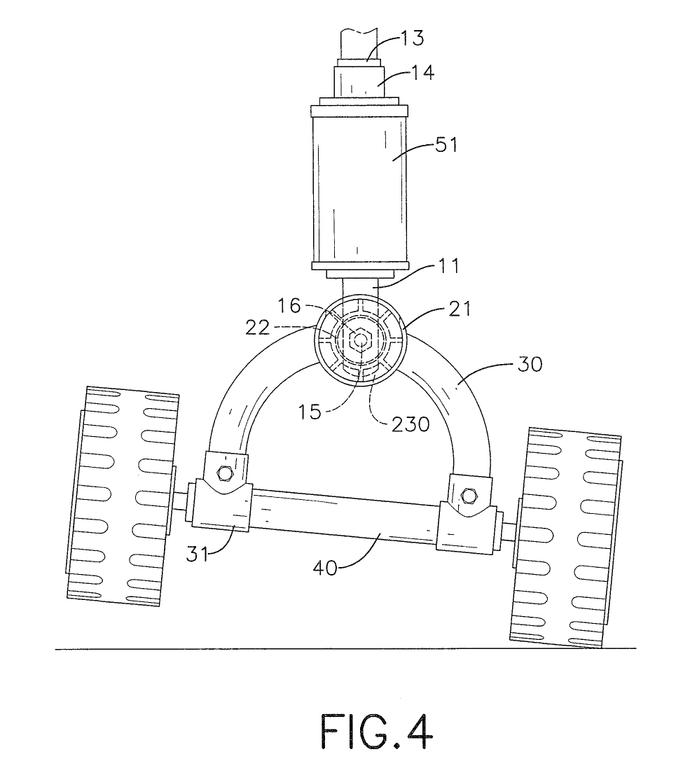

With further reference to FIG. 4, when the handlebar (52) turns with a bigger angle at a high speed, the stationary frames (30), the axle housing (40) and the housing (20) tilt. The pivotal bar (11) of the stem (10) slides in the pivot slot (212) of the outer tube (21) of the housing (20) and keeps the footboard (53) parallel to the ground and the stem (10) perpendicular to the ground. The users can stand on the footboard (53) of the scooter (50) stably.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pivoting handlebar assembly connector comprising:
a housing having
an outer tube having
a sidewall having an inner surface;
a pivot slot being formed transversely through the sidewall of the outer tube;
a front opening; and
a rear opening;
a mounting collar being mounted rotatably in the outer tube and having
a sidewall; and
two mounting slots being formed transversely through the sidewall of the mounting collar diametrically opposite to each other and aligning with the pivot slot in the outer tube; and
two end caps being mounted respectively in the front opening and the rear opening of the outer tube, and each end cap having
a disk corresponding to and closing a corresponding one of the front opening and the rear opening of the outer tube; and
a tube being formed coaxially on the disk, protruding into the corresponding opening in the outer tube and having a mounting hole being mounted around and holding the mounting collar;
two stationary frames being curved and being attached to the sidewall of the outer tube near the pivot slot diametrically opposite to each other, and each stationary frame having
an upper end being attached to the outer tube;
a bottom end; and
a tubular connector securely connecting to the bottom end of the stationary frame; and
a stem attaching to the housing and having
an upper end;
a bottom end;
a clamp being mounted around the stem;
a pivotal bar being formed coaxially on and protruding from the bottom end of the stem, attached to the mounting collar, pivotally extending into the housing and having
two sides; and
a pivot hole;
two washers being mounted rotatably in the mounting collar and respectively abutting opposite sides of the pivotal bar, and each washer having a through hole being formed concentrically through the washer;
a bolt extending through the washers and the pivotal bar; and
a nut screwing onto the bolt and squeezing the washers tightly against the pivotal bar.

2. The pivoting handlebar assembly connector as claimed in claim 1, wherein
each end cap further has multiple fins formed on the disk around the tube on the end cap and abutting the inner surface of the sidewall of the outer tube; and
the stem further has a gasket mounted around the stem and abutting with the clamp.
